(19) United States
(12) Patent Application Publication
(10) Pub. No.: US 2005/0166222 A1
(43) Pub. Date: Jul. 28, 2005

(54) Remote control device for television signal receiver capable of receiving emergency alert signals

(76) Inventors: Timothy Joseph Tully Jr, Noblesville, IN (US); John Douglas, Noblesville, IN (US); Michael Anthony, Noblesville, IN (US)

Correspondence Address: THOMSON LICENSING INC., PATENT OPERATIONS, PO BOX 5312, PRINCETON, NJ, 08543-5312, US

(21) Appl. No.: 10/513,905

(22) PCT Filed: May 9, 2003
(86) PCT No.: PCT/US03/14646

Related U.S. Application Data
(60) Provisional application No. 60/379,446, filed on May 10, 2002.
(60) Provisional application No. 60/379,557, filed on May 10, 2002.

(51) Int. Cl. H04N 7/10

(52) U.S. Cl. 725/33

(57) ABSTRACT

A remote control device for a television signal processing system is capable of receiving a signal indicating an emergency event and providing alert outputs to notify individuals of emergency events, while simultaneously transmitting control signals which control the television signal receiver. According to an exemplary embodiment, the remote control device includes a tuner operative to tune a frequency including a signal indicating an emergency event, and a transmitter operative to transmit a control signal which controls the television signal processing system.

### CROSS REFERENCE TO RELATED APPLICATIONS

This application claims priority to and all benefits accruing from two provisional applications filed in the United States Patent and Trademark Office on May 10, 2002, and there assigned Ser. Nos. 60/379,446 and 60/379,557.

### BACKGROUND OF THE INVENTION

1. Field of the Invention

The present invention generally relates to remote control devices, and more particularly, to a remote control device for a television signal processing system capable of, among other things, receiving emergency alert signals and providing alert outputs to notify individuals of emergency events.

2. Background Information

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOM are able to issue early warnings of severe weather conditions which have saved many lives. However, for such warnings to be effective, they must be communicated to their intended recipients.

Certain specialized radios and scanners are capable of receiving emergency alert signals provided by the NWS and NOM. However, such devices tend to be dedicated to this use, and generally offer consumers little, if any, functionality beyond monitoring these signals. Accordingly, in order to receive advance warning of weather-related emergencies, consumers are required to purchase a separate, dedicated device, which may be cost-prohibitive to some consumers.

Accordingly, there is a need for a device capable of receiving emergency alert signals which avoids the foregoing problems. The present invention addresses these and other issues.

### SUMMARY OF THE INVENTION

In accordance with an aspect of the present invention, a remote control device for a television signal processing system is disclosed. According to an exemplary embodiment, the remote control device comprises tuning means for tuning a frequency including a signal indicating an emergency event, and transmitting means for transmitting control signals which control the television signal processing system.

In accordance with another aspect of the present invention, a method for controlling a remote control device for a television signal processing system is disclosed. According to an exemplary embodiment, the method comprises steps of tuning a frequency including a signal indicating an emergency event, and transmitting a control signal which controls the television signal processing system while tuning the frequency.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary environment suitable for implementing the present invention;

FIG. 2 is a block diagram of an exemplary television signal processing system according to the present invention;

FIG. 3 is a block diagram of an exemplary remote control device according to the present invention; and

FIG. 4 is a flowchart illustrating exemplary steps according to the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

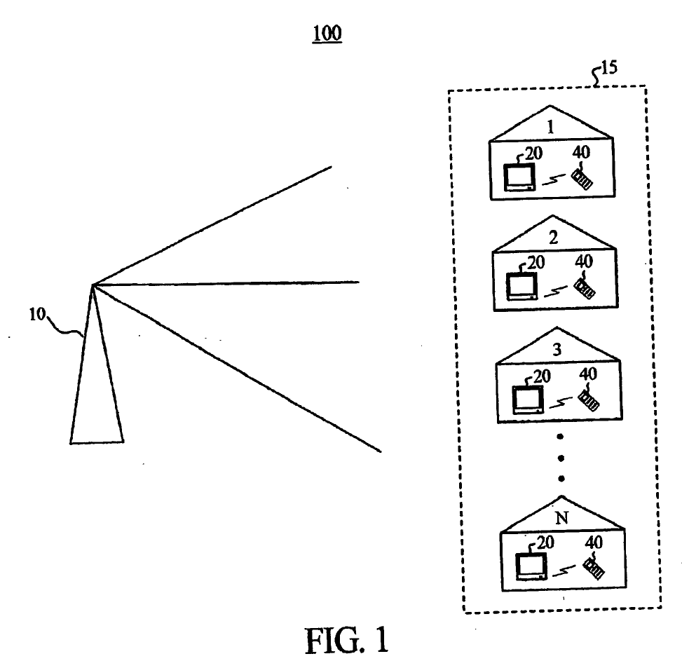

Referring now to the drawings, and more particularly to FIG. 1, an exemplary environment 100 suitable for implementing the present invention is shown. In FIG. 1, environment 100 comprises a signal transmission source 10 and dwelling units 15 (i.e., 1, 2, 3 . . . N, where N may be any positive integer). Dwelling units 15 in FIG. 1 may for example represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal processing system 20 having at least one associated remote control device 40. According to this exemplary embodiment, each television signal processing system 20 and/or each remote control device 40 is capable of receiving a signal indicating an emergency event, e.g., an emergency alert signal, and providing an alert output to notify individuals of the emergency event.

The television signal processing system may comprise various types of systems or signal processors such as television signal receivers that include a display device (such as a television set) or television signal receivers that do not include a display device (such as a set top box or VCR) but produce a signal suitable for coupling to a display device. For the purposes of the following detailed description, an exemplary embodiment of a system incorporating principles of the invention will be described in the context of a television receiver that includes a display device. However, the described aspects of the invention are also applicable to other types of television signal processing systems such as those that do not include a display device.

According to an exemplary embodiment, signal transmission source 10 transmits signals including a signal indicating an emergency event, e.g., an emergency alert signal, which may be received by each television signal receiver 20 and/or remote control device 40. As will be explained later herein, remote control device 40 is capable of receiving emergency alert signals transmitted from television signal receiver 20, and/or directly from signal transmission source 10. The emergency alert signals may for example be provided from an authority such as the NWS, or other authorities such as governmental entities or the like. In response to the emergency alert signals, each television signal receiver 20 and/or remote control device 40 may activate an emergency alert function and provide one or more alert outputs to thereby notify individuals of the emergency event. Signal transmission source 10 may, for example, transmit such emergency alert signals via any wired and/or wireless medium such as, but not limited to, terrestrial, cable, satellite, fiber optic, digital subscriber line (“DSL”), and/or other type of broadcast and/or multicast means.

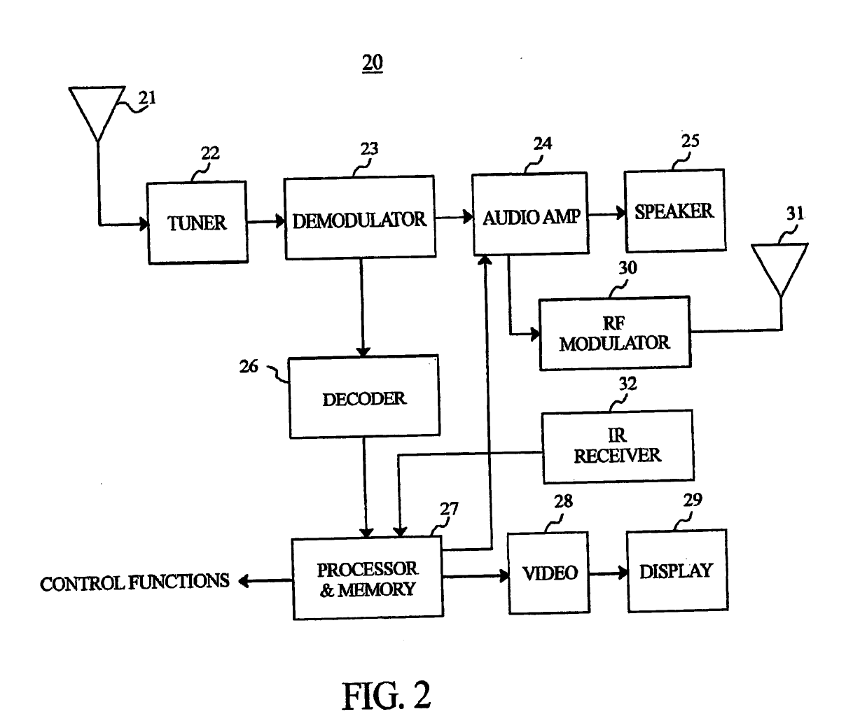

Referring now to FIG. 2, a block diagram of an exemplary television signal receiver 20 according to the present invention is shown. In FIG. 2, television signal receiver 20 comprises a signal receiving element 21, a tuner 22, a demodulator 23, an audio amplifier 24, a speaker 25, a decoder 26, a processor and memory 27, a video processor 28, a display 29, a radio frequency (RF) modulator 30, a signal transmitting element 31, and an infrared (IR) receiver 32. Some of the foregoing elements may for example be embodied using integrated circuits (ICs). For clarity of description, certain conventional elements of television signal receiver 20 may not be shown in FIG. 2.

Signal receiving element 21 is operative to receive signals including audio and/or video signals from signal sources, such as signal transmission source 10 in FIG. 1. According to an exemplary embodiment, received audio signals may additionally include digitally encoded emergency alert signals. Signal receiving element 21 may be embodied as any signal receiving element such as an antenna, input terminal or other element.

Tuner 22 is operative to tune signals received via signal receiving element 21 including audio and/or video signals. According to an exemplary embodiment, tuner 22 is capable of tuning audio signals on at least the following designated NWS frequencies: 162.400 MHz, 162.425 MHz, 162.450 MHz, 162.475 MHz, 162.500 MHz, 162.525 MHz and 162.550 MHz. Other frequencies may also be tuned. As previously indicated herein, such audio signals may additionally include digitally encoded emergency alert signals. Demodulator 23 is operative to demodulate signals provided from tuner 22.

According to an exemplary embodiment, demodulator 23 demodulates audio signals to thereby generate demodulated audio signals representing audio content such as an NWS audio message, a warning alert tone and/or other audio content. Audio amplifier 24 is operative to amplify the audio signals output from demodulator 23 responsive to a control signal provided from processor 27. Speaker 25 is operative to aurally output the amplified audio signals provided from audio amplifier 24.

Decoder 26 is operative to decode signals including audio and/or video signals. According to an exemplary embodiment, decoder 26 decodes audio signals provided from demodulator 23 to thereby extract digitally encoded frequency shift keyed (FSK) signals, which represent emergency alert signals indicating an emergency event. According to this exemplary embodiment, the emergency alert signals include data comprising specific area message encoding (SAME) data associated with the emergency event. SAME data comprises a digital code representing information such as the specific geographical area affected by the emergency event, the type of emergency event (e.g., tornado, toxic chemical spill, radiation leak, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of television signal receiver 20. According to an exemplary embodiment, processor 27 receives the emergency alert signals from decoder 26 and determines whether the emergency alert function of television signal receiver 20 is activated based on data included in the emergency alert signals. According to this exemplary embodiment, processor 27 compares data in the emergency alert signals to user setup data stored in memory 27 to determine whether the emergency alert function is activated. For example, a setup process for the emergency alert function of television signal receiver 20 may allow a user to select items such as an applicable geographical area(s), and type(s) of emergency events (e.g., tomado, toxic chemical spill, radiation leak, civil emergency, etc.) which activate the emergency alert function. As referred to herein, different severity levels (e.g., alert, watch, warning, etc.) may represent different “events.” For example, a thunderstorm watch may be considered a different event from a thunderstorm warning. Accordingly, the emergency alert function of television signal receiver 20 may be activated when the emergency event indicated by the emergency alert signals corresponds to a geographical area and/or event type designated by a user. According to an exemplary embodiment, when the emergency alert function is activated, processor 27 outputs one or more control signals which enable one or more alert outputs to thereby notify individuals of the emergency event. Such control signals may also enable other functions of television signal receiver 20, such as causing it to be switched from one mode, e.g., an off/standby mode, to another mode, e.g., an on mode.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays. Display 29 is operative to provide visual displays corresponding to processed signals provided from video processor 28. According to an exemplary embodiment, display 29 may provide visual displays including the aforementioned messages that provide details regarding emergency events.

RF modulator 30 is operative to modulate audio signals provided from audio amplifier 24. As previously indicated herein, such audio signals may include digitally encoded emergency alert signals and/or audio content such as an NWS audio message, a warning alert tone and/or other audio content.

Signal transmitting element, or transmitter, 31 is operative to transmit the RF modulated signals provided from RF modulator 30. According to an exemplary embodiment, these RF signals may be transmitted during all modes of operation, or during any one of a plurality of modes of operation, of the television signal processing system. The plurality of modes of operation includes, for example, an off/standby mode when the television signal processing system is turned off but continues to be connected to a source of power (e.g., AC mains) and is responsive to control signals such as a “turn on” signal from a user-activated remote control, when television signal receiver 20 is turned on and operating normally for viewing of television programming, and/or during a playback mode during which the television signal processing system is processing recorded audio and/or video content provided from a device such as a VCR, DVD player, PVR, CD player, etc. As will be explained later herein, remote control device 40 is operative to receive these RF signals which may include digitally encoded emergency alert signals, and perform the emergency alert function responsive to the emergency alert signals. Although the emergency alert signals are transmitted from television signal receiver 20 to remote control device 40 via RF transmission according to an exemplary embodiment, other types of transmissions such as an IR transmission (e.g., with repeater elements if necessary) or the like may also be used according to the present invention.

IR receiver 32 is operative to receive IR signals from remote control device 40. According to an exemplary embodiment, such IR signals may represent control signals which control the operation of television signal receiver 20. For example, such IR signals may control television signal receiver 20 by turning it on and off, changing channels, controlling volume, and/or controlling other functions of television signal receiver 20.

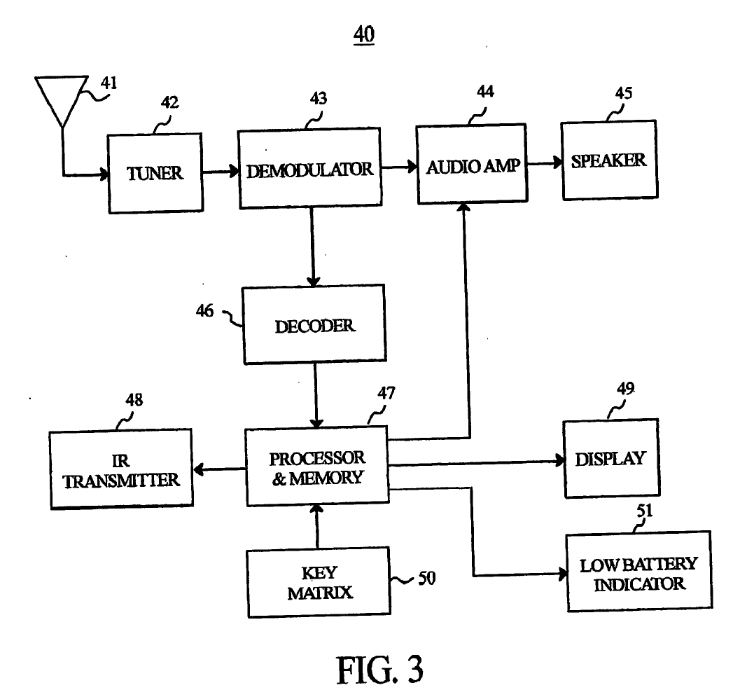

Referring to FIG. 3, a block diagram of an exemplary remote control device 40 according to the present invention is shown. In FIG. 3, remote control device 40 comprises a signal receiving element 41, a tuner 42, a demodulator 43, an audio amplifier 44, a speaker 45, a decoder 46, a processor and memory 47, an IR transmitter 48, a display 49, a key matrix 50, and a low battery indicator 51. Some of the foregoing elements may for example be embodied using ICs.

Signal receiving element 41 is operative to receive signals including emergency alert signals from signal sources, such as signal transmission source 10 and/or television signal receiver 20 of FIGS. 1 and 2. According to an exemplary embodiment, received audio signals may additionally include digitally encoded emergency alert signals. Signal receiving element 41 may be embodied as any signal receiving element such as an antenna or other element.

Tuner 42 is operative to tune signals received via signal receiving element 41 including audio signals which may additionally include emergency alert signals. According to an exemplary embodiment, tuner 42 is capable of tuning audio signals on at least the following designated NWS frequencies: 162.400 MHz, 162.425 MHz, 162.450 MHz, 162.475 MHz, 162.500 MHz, 162.525 MHz and 162.550 MHz. Other frequencies may also be tuned.

Demodulator 43 is operative to demodulate signals provided from tuner 42. According to an exemplary embodiment, demodulator 43 demodulates audio signals to thereby generate demodulated audio signals representing audio content such as an NWS audio message, a warning alert tone and/or other audio content. Audio amplifier 44 is operative to amplify the audio signals output from demodulator 43 responsive to a control signal provided from processor 47. Speaker 45 is operative to aurally output the amplified audio signals provided from audio amplifier 44.

Decoder 46 is operative to decode signals including audio signals having embedded emergency alert signals. According to an exemplary embodiment, decoder 46 decodes audio signals provided from demodulator 43 to thereby extract digitally encoded FSK signals, which represent emergency alert signals indicating an emergency event. According to this exemplary embodiment, the emergency alert signals include data comprising SAME data associated with the emergency event. As previously indicated herein, SAME data comprises a digital code representing information such as the specific geographical area affected by the emergency event, the type of emergency event (e.g., tornado, toxic chemical spill, radiation leak, civil emergency, etc.), and the expiration time of the event alert. As previously indicated herein, different severity levels (e.g., alert, watch, warning, etc.) may represent different “events.” Other data and information may also be included in the emergency alert signals according to the present invention.

Processor and memory 47 are operative to perform various processing and data storage functions of remote control device 40. According to an exemplary embodiment, the emergency alert function of remote control device 40 is activated whenever processor 47 receives emergency alert signals from decoder 46. According to this exemplary embodiment, the emergency alert function of remote control device 40 is activated regardless of the specific geographical area affected by the emergency event or the type of emergency event, as indicated by the emergency alert signals.

According to another exemplary embodiment, processor 47 receives the emergency alert signals from decoder 46 and determines whether the emergency alert function of remote control device 40 is activated based on data included in the emergency alert signals. According to this exemplary embodiment, processor 47 may compare data in the emergency alert signals to user setup data stored in memory 47 to determine whether the emergency alert function is activated. For example, a setup process for the emergency alert function of remote control device 40 may allow a user to select items such as an applicable geographical area(s), and type(s) of emergency events (e.g., tornado, toxic chemical spill, radiation leak, civil emergency, etc.) which activate the emergency alert function. Accordingly, the emergency alert function of remote control device 40 may be activated when the emergency event indicated by the emergency alert signals corresponds to a geographical area and/or event type designated by a user. According to an exemplary embodiment, when the emergency alert function is activated, processor 47 outputs one or more control signals which enable one or more alert outputs to thereby notify individuals of the emergency event.

IR transmitter 48 is operative to transmit IR signals to television signal receiver 20. As previously indicated herein, such IR signals may represent control signals which control the operation of television signal receiver 20, such as by turning it on and off, changing channels, controlling volume, and/or controlling other functions of television signal receiver 20. According to an exemplary embodiment, remote control device 40 is operative to transmit such IR control signals to television signal receiver 20 via IR transmitter 48 independently from receiving emergency alert signals and performing the emergency alert function. Accordingly, remote control device 40 may transmit IR control signals and thereby control television signal receiver 20 while simultaneously receiving emergency alert signals and performing the emergency alert function.

Display 49 is operative to provide visual displays corresponding to signals provided from processor 47. According to an exemplary embodiment, display 49 may provide visual displays including messages or other displays that provide details regarding emergency events. Data for such displays may for example be stored in memory 47 and output to display 49 when the emergency alert function of remote control device 40 is activated.

Key matrix 50 is operative to enable users to provide key inputs which control television signal receiver 20 and/or remote control device 40. For example, such inputs may cause IR transmitter 48 to transmit corresponding control signals to television signal receiver 20, as previously discussed herein. Moreover, such inputs may be used to control the emergency alert function and/or other functions of remote control device 40. For example, key matrix 50 may include a key which enables a user to turn off the emergency alert function of remote control device 40, and thereby preserve a battery (not shown) that provides electrical power to remote control device 40. According to an exemplary embodiment, remote control device 40 is still operative to transmit IR control signals and thereby control television signal receiver 20 when the emergency alert function of remote control device 40 is turned off.

Low battery indicator 51 is operative to provide a visual indication when the battery (not shown) that provides electrical power to remote control device 40 reaches a predetermined power level. Low battery indicator 51 may be embodied as any type of indicator element, such as a light-emitting diode (LED) or liquid crystal display (LCD) lamp or other indicator element. Low battery indicator 51 may also be included on display 49. Moreover, display 49, key matrix 50, and low battery indicator 51 may for example be included together on a viewable control panel of remote control device 40.

The exemplary embodiment of remote control device 40 shown in FIG. 3 may also be adapted for additional uses other than those expressly described above. For example, remote control device 40 may be adapted to transmit and/or receive any type of data to and/or from sources, such as signal transmission source 10 and/or television signal receiver 20. In this manner, remote control device 40 may for example provide bi-directional communication capabilities and thereby facilitate additional uses, such as a cordless telephone, mobile two-way radio, internet communication module, etc.

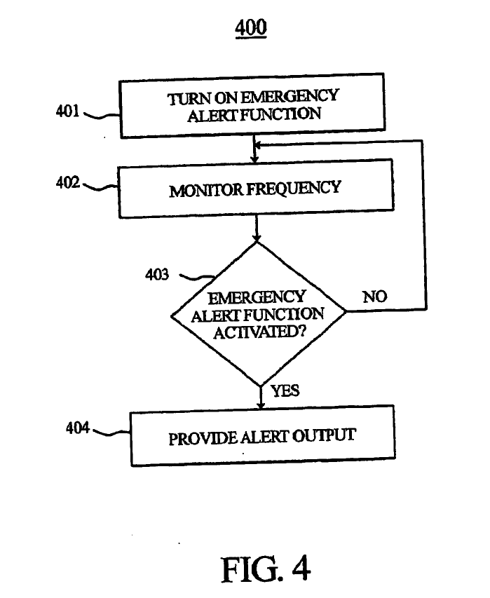

Referring to FIG. 4, a flowchart 400 illustrating exemplary steps according to the present invention is shown. For purposes of example and explanation, the steps of FIG. 4 will be described with reference to FIGS. 1 through 3. The steps of FIG. 4 are merely exemplary, and are not intended to limit the present invention in any manner.

At step 401, the emergency alert function of remote control device 40 is turned on. According to an exemplary embodiment, a user may turn on the emergency alert function of remote control device 40 by pressing a predetermined key on key matrix 50 which enables a battery (not shown) of remote control device 40 to provide electrical power to elements of remote control device 40 such as tuner 42, demodulator 43, and decoder 46, which enable reception of emergency alert signals. As previously indicated herein, remote control device 40 is capable of transmitting IR signals to control television signal receiver 20 even when the emergency alert function is turned off.

At step 402, remote control device 40 monitors a frequency for emergency alert signals. According to an exemplary embodiment, tuner 42 tunes the frequency and thereby receives incoming emergency alert signals. According to the present invention, tuner 42 may tune the frequency including emergency alert signals while IR transmitter 48 transmits IR control signals to television signal receiver 20. In this manner, remote control device 40 is capable of providing the emergency alert function and controlling television signal receiver 20 simultaneously.

As previously indicated herein, the emergency alert signals received by remote control device 40 at step 402 may be provided from television signal receiver 20. According to this exemplary embodiment, television signal receiver 20 is capable of transmitting emergency alert signals to remote control device 40 during all modes of operation, including for example when television signal receiver 20 is turned on, turned off, and/or during playback of recorded audio and/or video content.

The emergency alert signals may also be provided to remote control device 40 from a source other than television signal receiver 20, such as signal transmission source 10 of FIG. 1. According to this exemplary embodiment, remote control device 40 may receive emergency alert signals even during a power outage when, for example, television signal receiver 20 loses its source of electrical power. In this manner, remote control device 40 may operate as a portable, mobile device for providing the emergency alert function.

At step 403, a determination is made as to whether the emergency alert function of remote control device 40 is activated. As previously indicated herein, the emergency alert function of remote control device 40 may be activated whenever processor 47 receives emergency alert signals from decoder 46. According to this exemplary embodiment, the emergency alert function of remote control device 40 is activated regardless of the specific geographical area affected by the emergency event or the type of emergency event, as indicated by the emergency alert signals.

According to another exemplary embodiment, processor 47 receives the emergency alert signals from decoder 46 and determines whether the emergency alert function of remote control device 40 is activated at step 403 based on data included in the emergency alert signals. According to this exemplary embodiment, processor 47 may compare data in the emergency alert signals to user setup data stored in memory 47 to determine whether the emergency alert function is activated. As previously indicated herein, a setup process for the emergency alert function of remote control device 40 may allow a user to select items such as an applicable geographical area(s), and type(s) of emergency events (e.g., tornado, toxic chemical spill, radiation leak, civil emergency, etc.) which activate the emergency alert function. Accordingly, the emergency alert function of remote control device 40 may be activated when the emergency event indicated by the emergency alert signals corresponds to a geographical area and/or event type designated by a user.

If the determination at step 403 is negative, process flow loops back to step 402 where tuner 42 continues to monitor the frequency for emergency alert signals. Alternatively, if the determination at step 403 is positive, process flow advances to step 404 where remote control device 40 provides one or more alert outputs to thereby notify individuals of the emergency event. According to an exemplary embodiment, processor 47 enables the one or more alert outputs which may be aural and/or visual in nature. For example, aural outputs such as a warning tone, an NWS audio message and/or other aural output may be provided at step 404 via speaker 45, and the volume of such aural outputs may be controlled by processor 47. Visual outputs may also be provided at step 404 via display 49 to notify individuals of the emergency event. According to an exemplary embodiment, a visual display such as an NWS text message, icon, and/or other display may be provided at step 404 via display 49. As previously indicated herein, data for such displays may be stored in memory 47 and output to display 49 when the emergency alert function of remote control device 40 is activated. According to an exemplary embodiment, television signal receiver 20 and remote control device 40 may provide alert outputs at the same time.

As described herein, the present invention provides a remote control device for a television signal receiver capable of receiving emergency alert signals and providing alert outputs to notify individuals of emergency events. The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A remote control device for a television signal processing system, comprising:
a tuner operative to tune a frequency including a signal indicating an emergency event; and
a transmitter operative to transmit a control signal which controls the television signal processing system.

2. The remote control device of claim 1, wherein the tuner is operative to tune the frequency including the signal indicating the emergency event while the transmitter transmits the control signals.

3. The remote control device of claim 1, wherein an alert output is provided responsive to the signal indicating the emergency event.

4. The remote control device of claim 3, further comprising a display, and wherein the alert output comprises a visual output provided via the display.

5. The remote control device of claim 3, further comprising a speaker, and wherein the alert output comprises an aural output provided via the speaker.

6. The remote control device of claim 1, wherein the signal indicating the emergency event is provided from the television signal processing system.

7. The remote control device of claim 1, wherein the signal indicating the emergency event is provided from a source other than the television signal processing system.

8. A remote control device for a television signal processor, comprising:
tuning means for tuning a frequency including a signal indicating an emergency event; and
transmitting means for transmitting a control signal for controlling the television signal receiver.

9. The remote control device of claim 8, wherein the tuning means tunes the frequency including the signal indicating the emergency event while the transmitting means transmits the control signal.

10. The remote control device of claim 8, wherein an alert output is provided responsive to the signal indicating the emergency event.

11. The remote control device of claim 10, further comprising display means, and wherein the alert output comprises a visual output provided via the display means.

12. The remote control device of claim 10, further comprising aural output means, and wherein the alert output comprises an aural output provided via the aural output means.

13. The remote control device of claim 8, wherein the signal indicating the emergency event is provided from the television signal processor.

14. The remote control device of claim 8, wherein the signal indicating the emergency event is provided from a source other than the television signal processor.

15. A method for controlling a remote control device for a television signal processing system, comprising:
tuning a frequency including a signal indicating an emergency event; and
transmitting a control signal which controls the television signal receiver while tuning the frequency including the signal indicating the emergency event.

16. The method of claim 15, further comprised of providing an alert output responsive to the signal indicating the emergency event.

17. The method of claim 16, wherein the alert output comprises a visual output.

18. The method of claim 16, wherein the alert output comprises an aural output.

19. The method of claim 15, wherein the emergency alert signals are provided from the television signal processing system.

20. The method of claim 15, wherein the emergency alert signals are provided from a source other than the television signal processing system.

21. A television signal processing system comprising:
a tuner for tuning a frequency including a first signal indicating an emergency event; and
a transmitter included in the television signal processing system for transmitting a second signal indicating the emergency event to a remote control device.

22. The television signal processing system of claim 21, wherein the transmitter transmits the second signal to the remote control device for activating an emergency alert function of the remote control device.

23. The television signal processing system of claim 22, wherein the transmitter transmits the second signal to the remote control device during any one of a plurality of modes of operation of the television signal processing system.

24. The television signal processing system of claim 23, wherein the plurality of modes of operation comprises an on mode of the television signal processing system.

25. The television signal processing system of claim 23, wherein the plurality of modes of operation comprises an off/standby mode of the television signal processing system.

26. The television signal processing system of claim 23, wherein the plurality of modes of operation comprises a playback mode of the television signal processing system.
